(19) United States
(12) Patent Application Publication
(10) Pub. No.: US 2010/0171311 A1
(43) Pub. Date: Jul. 8, 2010

(54) Wave power generator

(76) Inventor: Edmund Albert Eckart, Pacific Palisades, CA (US)

Correspondence Address: EDMUND ALBERT ECKART JR., 15500 SUNSET BLVD., PACIFIC PALISADES, CA, 90272, US

(21) Appl. No.: 12/319,278

(22) Filed: Jan. 6, 2009

(51) Int. Cl. F03B 13/14; B63B 35/28; B63B 21/00; B63H 25/22; B63G 8/00; H02K 7/06; C02F 1/44

(52) U.S. Cl. 290/53; 114/26; 114/230.1; 114/150; 114/312; 310/83; 210/170.11

(57) ABSTRACT

This invention is a method of capturing renewable energy, using power from ocean waves approaching the continental shores of the world as they build to greater height and power on impact with the shallower waters, and the purpose of this invention is to extract from these waves the maximum amount of energy possible by utilizing pitching vessels in the form of barges anchored perpendicular to the incoming swells and in turn causing large heavy masses in the form of liquids or massive steel balls to shift backwards and forward as the waves pass under the vessel creating a free surface effect to either generate power, convert salt water to fresh, or a combination of both—with a goal of generating 1 megawatt of power per barge providing an average wave height of 5 ft.

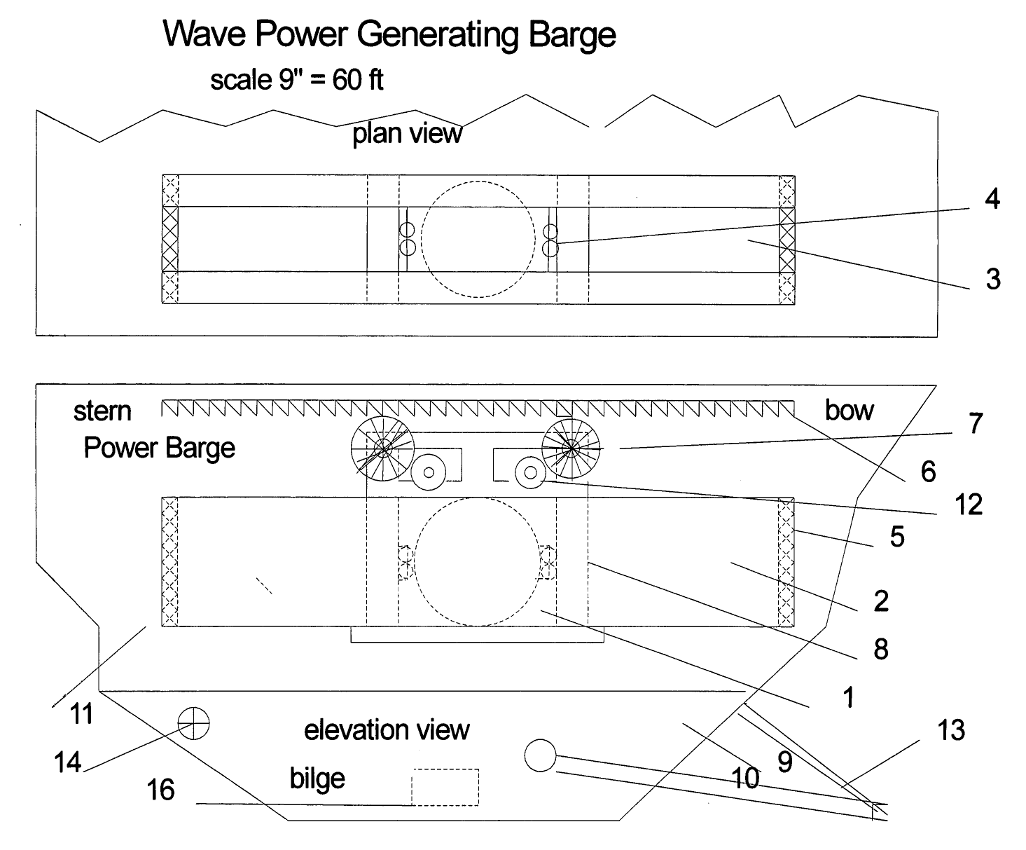

### BACKGROUND OF THE INVENTION

For many years scientists have struggled to recapture, for commercial use, the energy lost when the swells and waves of the great oceans of the world crash against the shores of the coastal areas. Trillions of megawatts of power are lost on the beaches, coral, reefs, and rocks. The invention addresses this lost power, and proposes a novel approach to harnessing the lost power to produce an endless supply of renewable energy.

### FIELD OF THE INVENTION

The field of the invention is the use of a moored pitching vessel-loaded with a constantly shifting mass which increases the angle of pitch known as “free surface effect”. This motion is converted to electrical power.

### DESCRIPTION OF RELATED ART

Many attempts have been made to harness the power of waves such as different buoy configurations. These devices usually rely on anchored buoys with power generated as swells work to lift the buoys while passing through them, and the strain on the buoy mooring line is converted to electric power. There are other approaches, including harnessing the power of the waves crashing against vertical walls. None have produced a cost effective mechanism that is storm proof.

### SUMMARY OF THE INVENTION

The invention utilizes “free surface effect to move massive weights [rolling steel balls] to increase the pitching motion of a moored vessel. The upward and downward pitching motion of a moored barge, facing seaward, makes possible the capture of substantial energy as the bow and stern of the vessel are lifted by each swell passing beneath the hull in sequence. Huge steel balls roll back and forth, pushing their cars through a round chambers, generating power on the way by the use of rack and pinion gear trains powering generators

. . . As an alternative, this moving ball driven car can be used as a ram to force salt water through a membrane, as in a reverse osmosis procedure, to develop fresh water. Another major feature is the ability of the mechanism to sink itself, in the event of a major storm by recognizing excessive power generation, and then commencing the submergence of the vessel by automatically opening flood gates. A large buoy, attached to the vessel with 50 feet of slack line during normal operations, will control its submerging depth to 50 feet below the surface—safely below storm driven monster waves. When the under sea motion subsides. battery powered bilge pumps 1 expel the water in the flooded bilge. The vessel is directed into a perpendicular attitude towards the in coming waves by the us of stern thrusters in the event of cross currents. The basic hull of the vessel is designed with greater buoyancy in the stem to equalize the loss of buoyancy as a swell passes under the hull.

### DETAILED DESCRIPTION OF THE PREFERRED EMBODIMENTS

The wave power generating barge/vessel is shown in the plan and elevation views. 1 is a steel ball which rolls fore & aft pushing car 8 through roller bearings 4—thus propelling car 8 to move to a stop position against cushion springs 5 & 11 at the end of it's passage, during a downward moment with a wave under the bow. During this motion, pinions 7 are rotated by contact with stationary rack 6

The rotating pinion gears in turn power generator 12.

This motion takes place as car 8 moves through a round restraining chamber 2 which is slotted the full length at the top to permit an exact fitting abutment of the car 8 to extend through the top opening slot in the cylinder housing and act as a mounting for the pinions 7 and generators 12.

9 is the ballast area used for flooding the barge in storms. 10 is the starboard mooring line with 13 the port mooring line-serving to hold the barge in position to contact the incoming waves. 14 are stern thrusters to hold the vessel perpendicular to the in coming waves when necessary. 15 is the bilge pump

### BRIEF DESCRIPTION OF THE DRAWINGS

A plan and elevation view of one section is shown of a total of 8 sections installed in a 100 ft wide wave generating barge. All 8 other sections are similar to the single section shown and are designed to be included in the barge plan. The illustrated plan view and the elevation view show a 50 ton steel ball 1. 8 is a movable car holding the steel bal. 4 are large roller ball bearings to eliminate friction while the 50 ton ball is rotating in motion. 7 is a pinion gear. 6 is a rack. 11 and 5 are restraining wall cushion springs. 12 are generators. 2 is the containing chamber in which the steel ball rolls. 15 is the car abutment fitting passing through 3 which is the open slot. 15 is also the abutment supporting the pinion and it's axel and the twin generators 7

9 is the bilge area that is flooded during storm periods. 15 is the battery powered bilge pump. 13 and 10 are mooring lines. 9 is the bilge area. 14 are stern thrusters.

1. I claim a method of using massive rolling steel balls through restrictive chambers actuated by the vertical pitching of an anchored vessel located in an area of heavy swells to produce renewable energy by developing electric power. through reverse osmosis membranes to convert to fresh water.

2. I claim an apparatus, which is designed as a moving car, enclosing heavy steel balls which car is moved backwards and forwards as waves pass under the vessel creating a rocking motion and in turn generating power through a rack and pinion gear train driving a generator.

3. I claim the above apparatus can be modified to produce fresh water by driving salt water through RO filters to produce fresh water instead of electric power

4. I claim the construction of a barge like vessel to be slightly less in length then the average wave length of inshore swells.

5. I claim a method of mooring a vessel/barge in such a manner that the attachment point of the mooring line is under the vessel at a fulcrum point thus reinforcing a maximum pitching motion

6. I claim a method of aligning the vessel perpendicular to the incoming wave lines by the use of bow thrusters

7. I claim a method of automatically sinking the barge to a prescribed depth in the event of a severe storm to minimize damage—involving the flooding of bilge tanks and utilizing a large buoy to regulate the depth of decent. This will be actuated when excessive power is being generated

8. I claim a method of constructing each vessel with a beam of approximately 100 feet to accommodate 9 steel ball chambers 10 feet in diameter and constructed with stern more buoyant then the bow to accommodate the loss of lift power as the wave passes under the heavy vessel.
